(19) United States
(12) Patent Application Publication
(10) Pub. No.: US 2025/0238182 A1
(43) Pub. Date: Jul. 24, 2025

(54) IMAGE FORMING APPARATUS AND OPERATION CONTROL METHOD CAPABLE OF EXECUTING PRINT JOB HELD IN PRINT SERVER

(71) Applicant: KYOCERA Document Solutions Inc., Osaka (JP)

(72) Inventor: Ikuya Ohara, Osaka (JP)

(21) Appl. No.: 19/034,478

(22) Filed: Jan. 22, 2025

(30) Foreign Application Priority Data
Jan. 23, 2024 (JP) 2024-007918

(51) Int. Cl. G06F 3/12

(52) U.S. Cl. CPC G06F 3/1267; G06F 3/1222; G06F 3/1238

(57) ABSTRACT

An image forming apparatus includes an acquisition processing portion and a first display processing portion. When a predetermined acquisition timing arrives, the acquisition processing portion starts an acquisition process of sequentially acquiring job information of print jobs held in a print server from the print server. In response to a predetermined specific operation received after the acquisition timing, the first display processing portion causes a display portion to display a list of the print jobs based on the job information acquired by the acquisition process before the specific operation is received.

### INCORPORATION BY REFERENCE

This application is based upon and claims the benefit of priority from the corresponding Japanese Patent Application No. 2024-007918 filed on Jan. 23, 2024, the entire contents of which are incorporated herein by reference.

### BACKGROUND

The present disclosure relates to an image forming apparatus and an operation control method.

There is known an image forming system capable of causing a display portion of an image forming apparatus to display a list of print jobs held in a print server.

### SUMMARY

An image forming apparatus according to an aspect of the present disclosure includes an acquisition processing portion and a first display processing portion. When a predetermined acquisition timing arrives, the acquisition processing portion starts an acquisition process of sequentially acquiring job information of print jobs held in a print server from the print server. In response to a predetermined specific operation received after the acquisition timing, the first display processing portion causes a display portion to display a list of the print jobs based on the job information acquired by the acquisition process before the specific operation is received.

An operation control method according to another aspect of the present disclosure includes an acquisition step and a display step. In the acquisition, when a predetermined acquisition timing arrives, an acquisition process of sequentially acquiring job information of print jobs held in a print server from the print server is started. In the display step, in response to a predetermined specific operation received after the acquisition timing, a list of the print jobs based on the job information acquired by the acquisition process before the specific operation is received is displayed on a display portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming system including an image forming apparatus according to an embodiment of the present disclosure.

FIG. 2 is a block diagram showing a configuration of the information processing apparatus included in the image forming system.

FIG. 3 is a block diagram showing a configuration of a print server included in the image forming system.

FIG. 4 is a block diagram showing a configuration of the image forming apparatus according to the embodiment of the present disclosure.

FIG. 5 is a flowchart showing an example of operation control processing executed in the image forming apparatus according to the embodiment of the present disclosure.

FIG. 6 is a flowchart showing an example of a first standby process executed in the image forming apparatus according to the embodiment of the present disclosure.

FIG. 7 is a flowchart showing an example of a third standby process executed in the image forming apparatus according to the embodiment of the present disclosure.

FIG. 8 is a flowchart showing an example of a second standby process executed in the image forming apparatus according to the embodiment of the present disclosure.

### DETAILED DESCRIPTION

Hereinafter, an embodiment of the present disclosure will be described with reference to the accompanying drawings. It is noted that the following embodiment is an example of embodying the present disclosure and does not limit the technical scope of the present disclosure.

### [Configuration of Image Forming System 100]

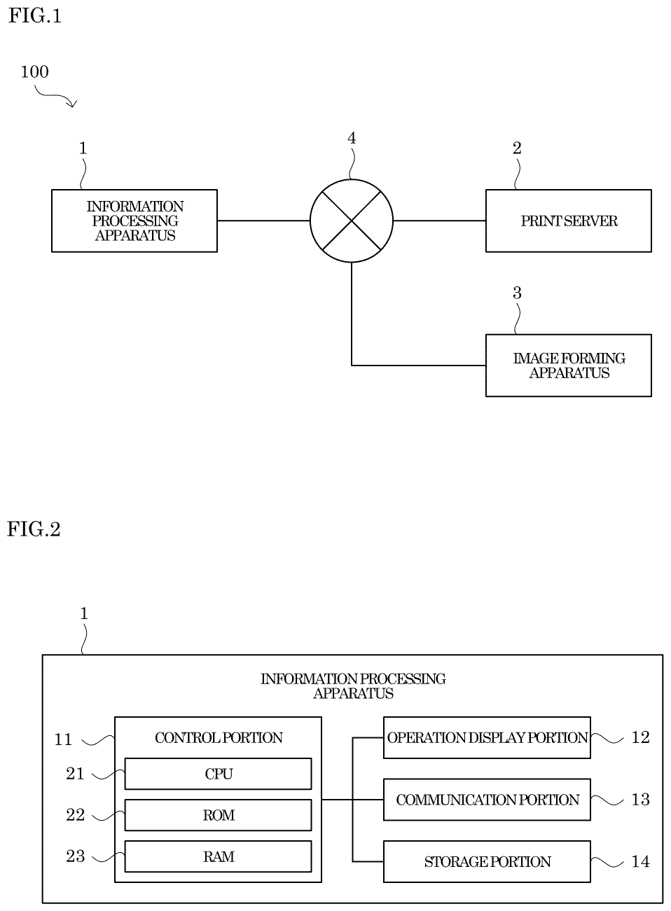

First, a configuration of an image forming system 100 including an image forming apparatus 3 according to the embodiment of the present disclosure will be described with reference to FIG. 1.

As shown in FIG. 1, the image forming system 100 includes an information processing apparatus 1, a print server 2, and an image forming apparatus 3. In the image forming system 100, the information processing apparatus 1, the print server 2, and the image forming apparatus 3 are each connected to a communication network 4. The information processing apparatus 1 and the print server 2 can communicate with each other via the communication network 4. In addition, the print server 2 and the image forming apparatus 3 can communicate with each other via the communication network 4. For example, the communication network 4 is the Internet.

In the image forming system 100, communication between the print server 2 and the image forming apparatus 3 is executed in accordance with a predetermined communication protocol. For example, the communication protocol is Internet Printing Protocol (IPP).

### [Configuration of Information Processing Apparatus 1]

Next, a configuration of the information processing apparatus 1 will be described with reference to FIG. 2.

The information processing apparatus 1 is a client terminal used by a first user of the print server 2. The first user is a user of the print service provided by the print server 2. In addition, the first user is a user registered in advance in the print server 2 as a user of the print service. The print service is a service for using the image forming apparatus 3 to print image data designated by the first user. For example, the information processing apparatus 1 is a personal computer or a notebook computer. It is noted that the information processing apparatus 1 may be a smartphone, a tablet terminal, or the like.

As shown in FIG. 2, the information processing apparatus 1 includes a control portion 11, an operation display portion 12, a communication portion 13, and a storage portion 14.

The control portion 11 performs overall control of the information processing apparatus 1. As shown in FIG. 2, the control portion 11 includes a CPU 21, a ROM 22, and a RAM 23. The CPU 21 is a processor that executes various types of arithmetic processing. The ROM 22 is a nonvolatile storage device in which information such as control programs for causing the CPU 21 to execute various types of processing are stored in advance. The RAM 23 is a volatile or nonvolatile storage device used as a temporary storage memory (work area) for various types of processing executed by the CPU 21. The CPU 21 executes various control programs stored in the ROM 22 in advance. The CPU 21 thereby performs overall control of the information processing apparatus 1.

The operation display portion 12 is a user interface of the information processing apparatus 1. The operation display portion 12 includes a first display portion and a first operation portion. The first display portion displays various types of information in response to control instructions from the control portion 11. For example, the first display portion is a flat panel display such as a liquid crystal display. The first operation portion inputs various types of information to the control portion 11 in response to user operations. For example, the first operation portion includes a keyboard, a mouse, and a touch panel.

The communication portion 13 is a communication interface for performing wired or wireless data communication with external communication devices such as the print server 2 via the communication network 4.

The storage portion 14 is a nonvolatile storage device. For example, the storage portion 14 is a storage device such as a nonvolatile memory such as a flash memory, a solid state drive (SSD), a hard disk drive (HDD), and the like.

### [Configuration of Print Server 2]

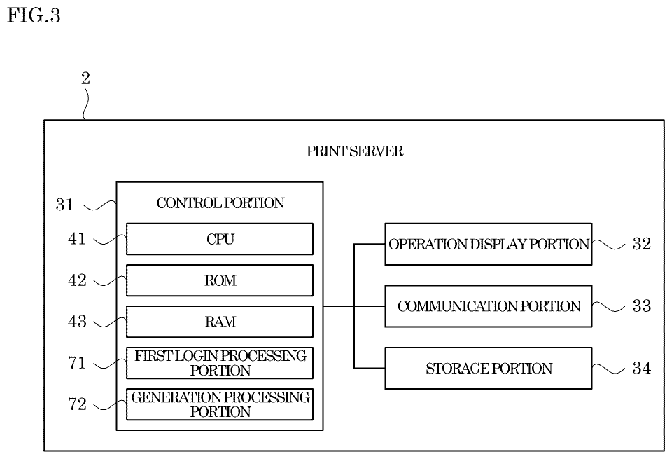

Next, a configuration of the print server 2 will be described with reference to FIG. 3.

The print server 2 is one or more information processing apparatuses that provide the print service to the first user. Herein, for convenience of description, an example in which the print server 2 is configured by one information processing apparatus will be described.

As shown in FIG. 3, the print server 2 includes a control portion 31, an operation display portion 32, a communication portion 33, and a storage portion 34.

The control portion 31 performs overall control of the print server 2. As shown in FIG. 3, the control portion 31 includes a CPU 41, a ROM 42, and a RAM 43. The CPU 41, the ROM 42, and the RAM 43 have functions similar to those of the CPU 21, the ROM 22, and the RAM 23 of the information processing apparatus 1.

The operation display portion 32 is a user interface of the print server 2. The operation display portion 32 includes a second display portion and a second operation portion. The second display portion displays various types of information in response to control instructions from the control portion 31. For example, the second display portion is a flat panel display such as a liquid crystal display. The second operation portion inputs various types of information to the control portion 31 in response to user operations. For example, the second operation portion includes a keyboard, a mouse, and a touch panel.

The communication portion 33 is a communication interface for performing wired or wireless data communication with external communication devices such as the information processing apparatus 1 and the image forming apparatus 3 via the communication network 4.

The storage portion 34 is a nonvolatile storage device similar to the storage portion 14 of the information processing apparatus 1.

First account information corresponding to each of the first users is stored in the storage portion 34 in advance. The first account information includes identification information of the first user such as a user ID, and a password.

In addition, the storage portion 34 stores, in advance, a first print service program for providing the print service to the first user. The CPU 41 of the control portion 31 executes the first print service program to function as a first login processing portion 71 and a generation processing portion 72 shown in FIG. 3.

The first login processing portion 71 causes the first user to log in the print server 2.

Specifically, the first login processing portion 71 causes the operation display portion 12 of the information processing apparatus 1 to display a first authentication screen used for authentication of the first user in response to a user operation instructing an access to the print server 2 on the operation display portion 12. On the first authentication screen, a user operation of inputting identification information of the first user and a password is received. When information is input by the user operation on the first authentication screen, the first login processing portion 71 determines whether or not the input information matches any of the first account information stored in the storage portion 34. When the information input on the first authentication screen matches any of the first account information stored in the storage portion 34, the first login processing portion 71 determines that the authentication is successful and causes the first user to log in the print server 2.

The generation processing portion 72 generates a print job for printing image data designated by the first user. The print job is a job to be executed by the image forming apparatus 3.

For example, the generation processing portion 72 causes the operation display portion 12 of the information processing apparatus 1 to display a print target designation screen used to designate image data to be printed, in response to a predetermined operation performed by the first user on the operation display portion 12. When the image data to be printed is designated by the operation performed by the first user on the print target designation screen, the generation processing portion 72 generates the print job for printing the designated image data. In addition, the generation processing portion 72 stores the generated print job in the storage portion 34.

In addition, when the print job is generated, the generation processing portion 72 stores job information of the generated print job in the storage portion 34. For example, the job information includes a job ID used for identification of the print job, identification information of the first user, name information of a print target, page number information of the print target, and generation timing information of the print job.

### [Configuration of Image Forming Apparatus 3]

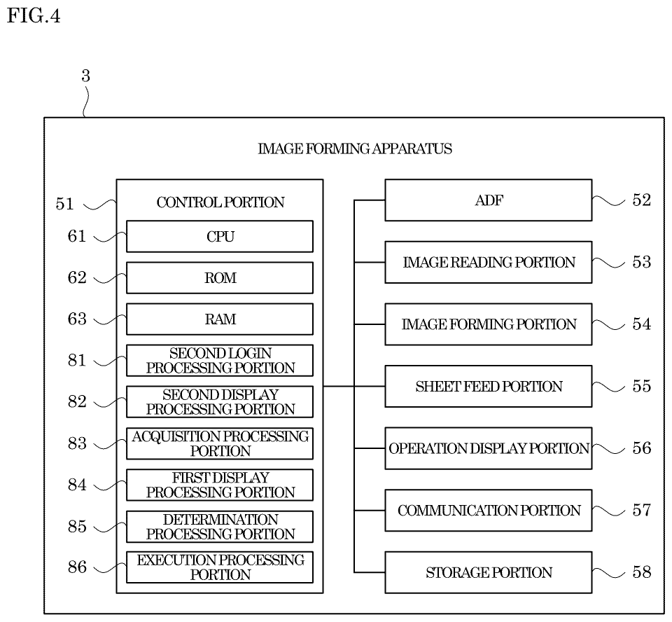

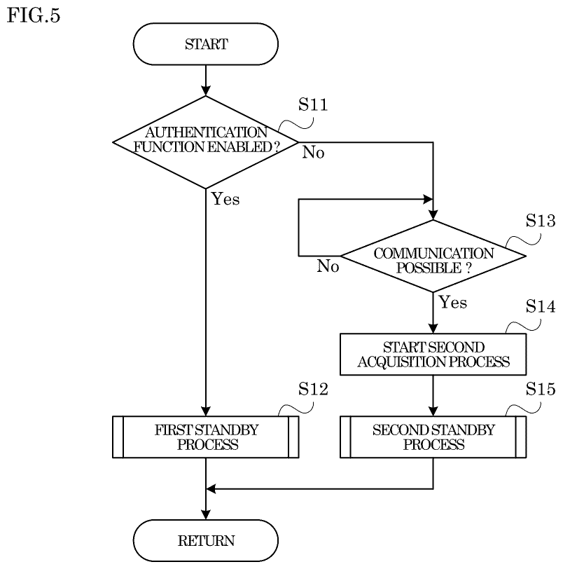

Next, a configuration of the image forming apparatus 3 will be described with reference to FIG. 4.

The image forming apparatus 3 executes the print job held in the print server 2. Specifically, the image forming apparatus 3 is a multi-functional peripheral having a print function of forming an image on a sheet based on image data, and a plurality of other functions such as a scan function, a facsimile function, and a copy function. It is noted that the image forming apparatus 3 may be a printer, a facsimile machine, a copier, or the like which has the print function.

As shown in FIG. 4, the image forming apparatus 3 includes a control portion 51, an automatic document feeder (ADF) 52, an image reading portion 53, an image forming portion 54, a sheet feed portion 55, an operation display portion 56, a communication portion 57, and a storage portion 58.

The control portion 51 performs overall control of the image forming apparatus 3. As shown in FIG. 4, the control portion 51 includes a CPU 61, a ROM 62, and a RAM 63. The CPU 61, the ROM 62, and the RAM 63 have functions similar to those of the CPU 21, the ROM 22, and the RAM 23 of the information processing apparatus 1.

The ADF 52 conveys a document sheet whose image is read by the image reading portion 53. The ADF 52 includes a document sheet loading portion, a plurality of conveying rollers, a document sheet holder, and a sheet discharge portion.

The image reading portion 53 implements the scan function. The image reading portion 53 includes a document sheet table, a light source, a plurality of mirrors, an optical lens, and a CCD.

The image forming portion 54 implements the print function. For example, the image forming portion 54 forms a color or monochrome image on a sheet supplied by the sheet feed portion 55, using an electrophotographic method. For example, the image forming portion 54 includes a plurality of image forming units, a laser scanning unit, an intermediate transfer belt, a secondary transfer roller, a fixing device, and a sheet discharge tray. It is noted that the image forming portion 54 may form an image on a sheet supplied by the sheet feed portion 55, using another image forming method such as an inkjet method.

The sheet feed portion 55 supplies a sheet to the image forming portion 54. The sheet feed portion 55 includes a sheet feed cassette, a manual feed tray, and a plurality of conveying rollers.

The operation display portion 56 is a user interface of the image forming apparatus 3. The operation display portion 56 includes a third display portion and a third operation portion. The third display portion displays various types of information in response to control instructions from the control portion 51. For example, the third display portion is a flat panel display such as a liquid crystal display. The third operation portion inputs various types of information to the control portion 51 in response to user operations. For example, the third operation portion includes an operation key and a touch panel.

The communication portion 57 is a communication interface for performing wired or wireless data communication with external communication devices such as the print server 2 via the communication network 4.

The storage portion 58 is a nonvolatile storage device similar to the storage portion 14 of the information processing apparatus 1.

Second account information corresponding to each of second users of the image forming apparatus 3 is stored in the storage portion 58 in advance. The second user is a user registered in the image forming apparatus 3 in advance as a user of the image forming apparatus 3. The second account information includes identification information of the second user such as a user ID, and a password. The second account information is associated with the identification information of the first user in advance.

In addition, an authentication program for authenticating the second user is stored in the storage portion 58 in advance. The CPU 61 of the control portion 51 executes the authentication program to function as a second login processing portion 81 and a second display processing portion 82 shown in FIG. 4.

The second login processing portion 81 causes the second user to log in the image forming apparatus 3. The second user is an example of the registered user of the present disclosure. In addition, the second login processing portion 81 is an example of the login processing portion of the present disclosure.

For example, when an authentication function of the second user is set to be enabled and a user operation is received on the operation display portion 56, the second login processing portion 81 causes the operation display portion 56 to display a second authentication screen used for the authentication of the second user. On the second authentication screen, a user operation of inputting identification information of the second user and a password is received. It is noted that the authentication function is enabled or disabled in response to a predetermined user operation on the operation display portion 56.

When information is input by the user operation on the second authentication screen, the second login processing portion 81 determines whether or not the input information matches any of the second account information stored in the storage portion 58. When the information input on the second authentication screen matches any of the second account information stored in the storage portion 58, the second login processing portion 81 determines that the authentication is successful and causes the second user to log in the image forming apparatus 3.

It is noted that the second login processing portion 81 executes a logout process of logging out the logged-in second user when a predetermined logout operation is performed on the operation display portion 56, when a predetermined time has elapsed, or when another second user is to be logged in.

The second display processing portion 82 causes the operation display portion 56 (an example of the display portion of the present disclosure) to display a function selection screen used to select a function to be used.

For example, if the authentication function is set to be enabled, the second display processing portion 82 causes the operation display portion 56 to display the function selection screen when the second user logs in the image forming apparatus 3.

In addition, if the authentication function is set to be disabled, the second display processing portion 82 causes the operation display portion 56 to display the function selection screen when a user operation is received on the operation display portion 56.

The function selection screen is a so-called main menu screen. On the function selection screen, a function to be used can be selected from various functions of the image forming apparatus 3. The functions that can be selected on the function selection screen include a specific function of executing the print job held in the print server 2.

By the way, in the image forming apparatus 3, a job list of the print jobs held in the print server 2 can be displayed on the operation display portion 56.

Here, in the image forming system 100, the communication protocol that defines the communication procedures between the print server 2 and the image forming apparatus 3 limits the job information of the print jobs that can be transmitted in one communication and is used for display of the job list to only one. Therefore, when sequential acquisition of the job information is started in the image forming apparatus 3 after the display instruction of the job list is input by the user, the waiting time for the user until the job list is displayed is long.

On the other hand, in the image forming apparatus 3 according to the embodiment of the present disclosure, as will be described below, it is possible to reduce the waiting time for the user until the job list of the print jobs held in the print server 2 is displayed.

Specifically, the storage portion 58 of the image forming apparatus 3 stores in advance a second print service program for causing the control portion 51 to function as an acquisition processing portion 83, a first display processing portion 84, a determination processing portion 85, and an execution processing portion 86 shown in FIG. 4. The CPU 61 of the control portion 51 executes the second print service program to function as the aforementioned processing portions.

It is noted that some or all of the processing portions included in the control portion 51 of the image forming apparatus 3 may be constituted by electronic circuits. In addition, the authentication program and the second print service program may be a program for causing a plurality of processors to function as the processing portions shown in FIG. 4.

When a predetermined acquisition timing arrives, the acquisition processing portion 83 starts an acquisition process of sequentially acquiring the job information of the print jobs held in the print server 2 from the print server 2 in accordance with the communication protocol.

Here, the acquisition timing differs depending on whether the authentication function is enabled or disabled.

For example, the acquisition timing when the authentication function is enabled (hereinafter referred to as a “first acquisition timing”) is a timing when the specific function is selected as the function to be used on the function selection screen.

The acquisition timing when the authentication function is disabled (hereinafter referred to as a “second acquisition timing”) is a timing when communication with the print server 2 in accordance with the communication protocol is enabled.

In the acquisition process executed when the first acquisition timing arrives (hereinafter referred to as a “a first acquisition process”), the job information of the print jobs corresponding to the logged-in second user is sequentially acquired.

For example, in the first acquisition process, the first user corresponding to the logged-in second user is recognized based on the identification information of the first user associated with the second account information of the logged-in second user. In addition, in the first acquisition process, a list of the job IDs of the print jobs of the first user corresponding to the logged-in second user (hereinafter referred to as a “first job ID list”) is acquired from the print server 2. Then, in the first acquisition process, the job information of the print jobs corresponding to the logged-in second user is sequentially acquired using the acquired first job ID list. The job information acquired in the first acquisition process is stored in a predetermined specific storage area in the RAM 63.

For example, in the first acquisition process, the job information is acquired once for each of the job IDs included in the first job ID list. In the first acquisition process, after the job information is acquired once for all the job IDs included in the first job ID list, a retry is performed a predetermined number of times for each of the job IDs for which the acquisition of the job information has failed.

For example, the first acquisition process is repeatedly executed until the second user logs out or the authentication setting is switched from enabled to disabled.

In addition, in the acquisition process executed when the second acquisition timing arrives (hereinafter referred to as a “second acquisition process”), the job information of all the print jobs held in the print server 2 is sequentially acquired.

For example, in the second acquisition process, a list of the job IDs of all the print jobs held in the print server 2 (hereinafter referred to as a “second job ID list”) is acquired from the print server 2. In the second acquisition process, the job information of all the print jobs held in the print server 2 is sequentially acquired using the acquired second job ID list. The job information acquired in the second acquisition process is stored in the specific storage area in the RAM 63.

For example, in the second acquisition process, the job information is acquired once for each of the job IDs included in the second job ID list. In the second acquisition process, after the job information is acquired once for all the job IDs included in the second job ID list, a retry is performed a predetermined number of times for each of the job IDs for which the acquisition of the job information has failed.

For example, the second acquisition process is repeatedly executed until the authentication setting is switched from disabled to enabled.

In response to a predetermined specific operation received after the acquisition timing, the first display processing portion 84 causes the operation display portion 56 to display the job list (an example of the list of the present disclosure) of the print jobs based on the job information acquired by the acquisition process before the specific operation is received.

For example, in the image forming apparatus 3, when the authentication function is enabled and the specific function is selected as the function to be used on the function selection screen, a user icon image indicating the first user corresponding to the logged-in second user is displayed on the operation display portion 56.

In addition, in the image forming apparatus 3, when the authentication function is disabled and the specific function is selected as the function to be used on the function selection screen, the user icon image indicating each of the first users whose identification information is stored in the specific storage area is displayed on the operation display portion 56.

For example, the specific operation is a selection operation on the user icon image.

For example, if the specific operation is received when the authentication function is disabled, the first display processing portion 84 causes the operation display portion 56 to display the job list of the print jobs of the first user corresponding to the user icon image selected by the specific operation.

For example, the job list includes the job ID of each of the print jobs to be displayed, name information of the print target, page number information of the print target, and generation timing information of the print job.

In addition, in response to a predetermined update operation received after the display of the job list, the first display processing portion 84 updates the job list based on the job information acquired by the acquisition process before the update operation is received.

For example, the job list includes an update operation key used for the update operation. In this case, the update operation is an operation on the update operation key.

It is noted that the first display processing portion 84 may update the job list every time the job information is acquired by the acquisition process.

In response to a designation operation of designating any of the print jobs included in the job list displayed by the first display processing portion 84, the determination processing portion 85 determines whether or not the print job designated by the designation operation is held in the print server 2.

Specifically, the determination processing portion 85 determines whether or not the print job designated by the designation operation is held in the print server 2 based on a result of a reply by the print server 2 to an inquiry as to whether or not the print job designated by the designation operation is held in the print server 2.

The execution processing portion 86 executes the print job designated by the designation operation when the determination processing portion 85 determines that the print job designated by the designation operation is held in the print server 2.

Specifically, the execution processing portion 86 acquires the print job designated by the designation operation from the print server 2, and executes the acquired print job.

In addition, when the determination processing portion 85 determines that the print job designated by the designation operation is not held in the print server 2, the execution processing portion 86 notifies the user that the print job designated by the designation operation cannot be executed.

### [Operation Control Processing]

Next, the operation control method of the present disclosure will be described below with reference to FIG. 5, along with an example of the procedure of the operation control processing executed by the control portion 51 of the image forming apparatus 3. Here, steps S11, S12, . . . represent the numbers of the processing procedure (steps) executed by the control portion 51. It is noted that the operation control processing is executed when the power of the image forming apparatus 3 is turned on.

### <Step S11>

First, in step S11, the control portion 51 determines whether or not the authentication function is enabled.

Here, when the control portion 51 determines that the authentication function is enabled (Yes in S11), the control portion 51 shifts the processing to step S12. In addition, when the authentication process is not enabled (No in S11), the control portion 51 shifts the processing to step S13.

### <Step S12>

In step S12, the control portion 51 executes a first standby process to be described below.

### <Step S13>

In step S13, the control portion 51 determines whether or not communication with the print server 2 according to the communication protocol has been enabled.

When the control portion 51 determines that communication with the print server 2 according to the communication protocol has been enabled (Yes in S13), the control portion 51 shifts the processing to step S14. In addition, when the communication with the print server 2 according to the communication protocol has not been enabled (No in S13), the control portion 51 waits for the communication with the print server 2 according to the communication protocol to be enabled in step S13.

### <Step S14>

In step S14, the control portion 51 starts the second acquisition process. The process of step S14 is another example of the acquisition step of the present disclosure, and is executed by the acquisition processing portion 83 of the control portion 51.

### <Step S15>

In step S15, the control portion 51 executes a second standby process to be described later.

### [First Standby Process]

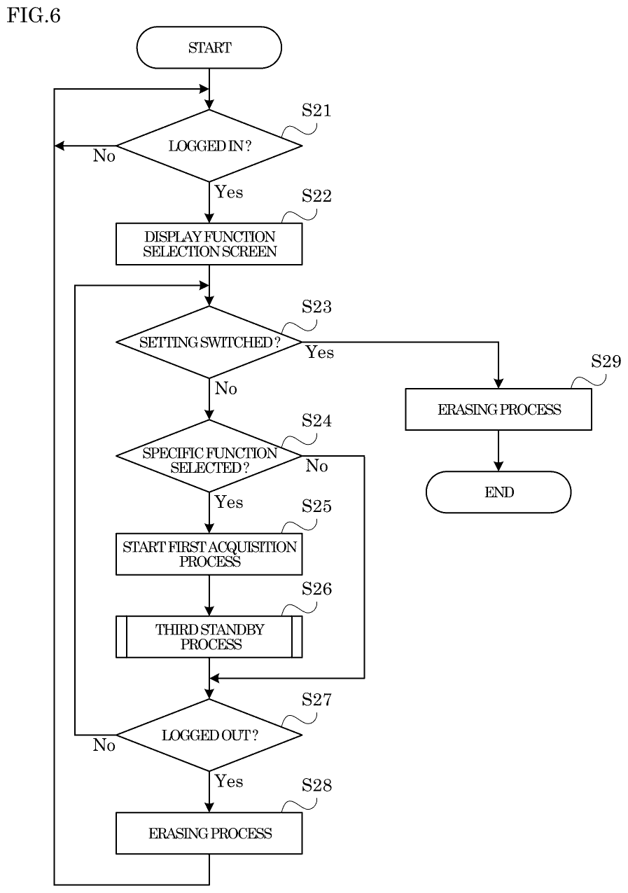

Next, an example of the first standby process executed in step S12 of the operation control processing will be described with reference to FIG. 6.

### <Step S21>

First, in step S21, the control portion 51 determines whether or not the second user has logged in the image forming apparatus 3.

Here, when the control portion 51 determines that the second user has logged in the image forming apparatus 3 (Yes in S21), the control portion 51 shifts the processing to step S22. When the second user has not logged in the image forming apparatus 3 (No in S21), the control portion 51 waits for the second user to log in the image forming apparatus 3 in step S21.

### <Step S22>

In step S22, the control portion 51 causes the operation display portion 56 to display the function selection screen. The process of step S22 is executed by the second display processing portion 82 of the control portion 51.

### <Step S23>

In step S23, the control portion 51 determines whether or not the setting of the authentication function has been switched from enabled to disabled.

Here, when the control portion 51 determines that the setting of the authentication function has been switched from enabled to disabled (Yes in S23), the control portion 51 shifts the processing to step S29. In addition, when the setting of the authentication function has not been switched (No in S23), the control portion 51 shifts the processing to step S24.

### <Step S24>

In step S24, the control portion 51 determines whether or not the specific function has been selected as the function to be used on the function selection screen.

Here, when the control portion 51 determines that the specific function has been selected as the function to be used (Yes in S24), the control portion 51 shifts the processing to step S25. In addition, when the specific function has not been selected as the function to be used (No in S24), the control portion 51 shifts the processing to step S27.

### <Step S25>

In step S25, the control portion 51 starts the first acquisition process. The process of step S25 is an example of the acquisition step of the present disclosure, and is executed by the acquisition processing portion 83 of the control portion 51.

### <Step S26>

In step S26, the control portion 51 executes a third standby process to be described later.

### <Step S27>

In step S27, the control portion 51 determines whether or not the logged-in second user has logged out of the image forming apparatus 3.

Here, when the control portion 51 determines that the logged-in second user has logged out of the image forming apparatus 3 (Yes in S27), the control portion 51 shifts the processing to step S28. In addition, when the logged-in second user has not logged out of the image forming apparatus 3 (No in S27), the control portion 51 shifts the processing to step S23.

It is noted that when a function different from the specific function is selected as the function to be used on the function selection screen, the control portion 51 may cause the operation display portion 56 to display a setting screen of the selected function and execute a process corresponding to the selected function in accordance with a user operation on the setting screen.

### <Step S28>

In step S28, the control portion 51 executes an erasing process of erasing the job information stored in the specific storage area.

### <Step S29>

In step S29, the control portion 51 executes the erasing process.

### [Third Standby Process]

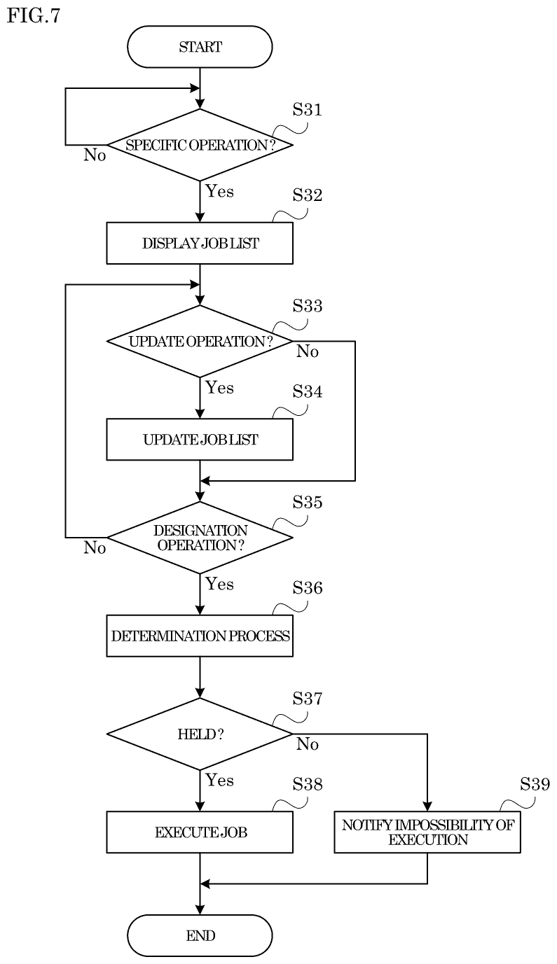

Next, an example of the third standby process executed in step S26 of the first standby process will be described with reference to FIG. 7.

### <Step S31>

In step S31, the control portion 51 determines whether or not the specific operation has been received.

Specifically, the control portion 51 determines that the specific operation has been received when a selection operation on the user icon image indicating the first user corresponding to the logged-in second user, which is displayed on the operation display portion 56 in response to a selection operation of the specific function on the function selection screen, has been received.

Here, when the control portion 51 determines that the specific operation has been received (Yes in S31), the control portion 31 shifts the processing to step S32. In addition, when the specific operation has not been received (No in S31), the control portion 51 waits for the specific operation to be received in step S31.

### <Step S32>

In step S32, the control portion 51 causes the operation display portion 56 to display the job list of the print jobs based on the job information acquired by the first acquisition process before the specific operation is received. The process of step S32 is an example of the display step of the present disclosure, and is executed by the first display processing portion 84 of the control portion 51.

### <Step S33>

In step S33, the control portion 51 determines whether or not the update operation has been received.

Specifically, the control portion 51 determines that the update operation has been received when an operation on the update operation key included in the job list is received.

Here, when the control portion 51 determines that the update operation has been received (Yes in S33), the control portion 51 shifts the processing to step S34. In addition, when the update operation has not been received (No in S33), the control portion 51 shifts the processing to step S35.

### <Step S34>

In step S34, the control portion 51 updates the job list based on the job information acquired by the first acquisition process before the update operation is received. The process of step S34 is executed by the first display processing portion 84 of the control portion 51.

### <Step S35>

In step S35, the control portion 51 determines whether or not the designation operation of designating any of the print jobs included in the job list has been received.

Here, when the control portion 51 determines that the designation operation has been received (Yes in S35), the control portion 51 shifts the processing to step S36. In addition, when the designation operation has not been received (No in S35), the control portion 51 shifts the processing to step S33.

### <Step S36>

In step S36, the control portion 51 executes a determination process of determining whether or not the print job designated by the designation operation is held in the print server 2. The process of step S36 is executed by the determination processing portion 85 of the control portion 51.

### <Step S37>

In step S37, the control portion 51 branches the processing in accordance with the result of the determination process. Specifically, when the control portion 51 determines that the print job designated by the designation operation is held in the print server 2 (Yes in S37), the control portion 51 shifts the processing to step S38. When it is determined that the print job designated by the designation operation is not held in the print server 2 (No in S37), the control portion 51 shifts the processing to step S39.

### <Step S38>

In step S38, the control portion 51 executes the print job designated by the designation operation. The process of step S38 is executed by the execution processing portion 86 of the control portion 51.

### <Step S39>

In step S39, the control portion 51 notifies the user that the print job designated by the designation operation cannot be executed. The process of step S39 is executed by the execution processing portion 86 of the control portion 51.

For example, the control portion 51 causes the operation display portion 56 to display a message indicating that the print job cannot be executed because the print job does not exist in the print server 2.

### [Second Standby Process]

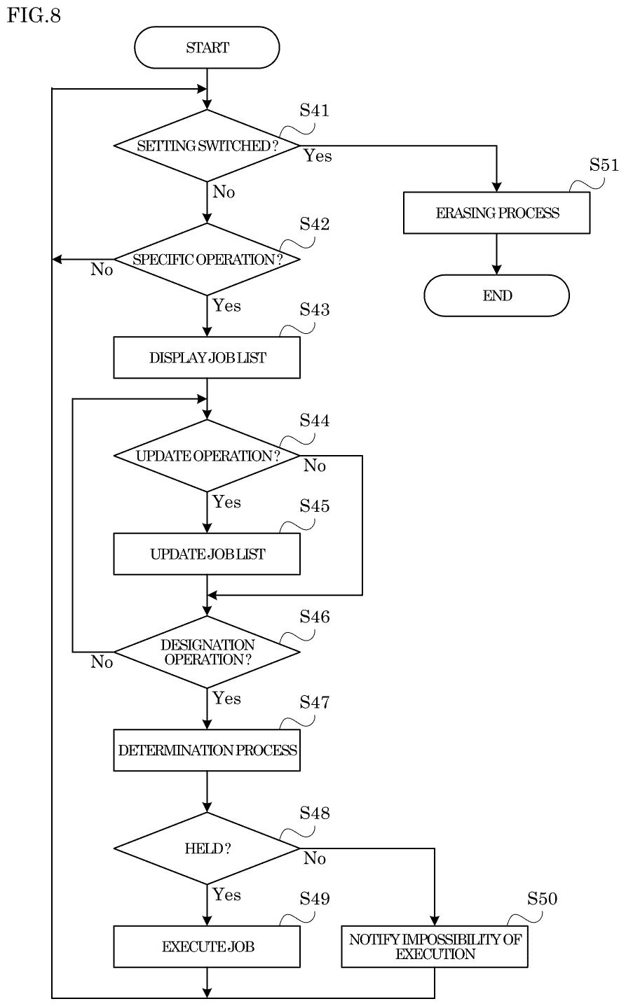

Next, an example of the procedure of the second standby process executed in step S15 of the operation control processing will be described with reference to FIG. 8.

### <Step S41>

First, in step S41, the control portion 51 determines whether or not the setting of the authentication function has been switched from disabled to enabled.

Here, when the control portion 51 determines that the setting of the authentication function has been switched from disabled to enabled (Yes in S41), the control portion 51 shifts the processing to step S51. In addition, when the setting of the authentication function has not been switched (No in S41), the control portion 51 shifts the processing to step S42.

### <Step S42>

In step S42, the control portion 51 determines whether or not the specific operation has been received.

Specifically, the control portion 51 determines that the specific operation has been received when a selection operation on any of the user icon images, which are displayed on the operation display portion 56 in response to a selection operation of the specific function on the function selection screen and indicate the respective first users whose identification information is stored in the specific storage area, is received.

Here, when the control portion 51 determines that the specific operation has been received (Yes in S42), the control portion 51 shifts the processing to step S43. In addition, when the specific operation has not been received (No in S42), the control portion 51 shifts the processing to step S41.

### <Step S43>

In step S43, the control portion 51 causes the operation display portion 56 to display the job list of the print jobs of the first user selected by the specific operation, based on the job information acquired by the second acquisition process before the specific operation is received. The process of step S43 is another example of the display step of the present disclosure, and is executed by the first display processing portion 84 of the control portion 51.

### <Step S44>

In step S44, the control portion 51 determines whether or not the update operation has been received.

Here, when the control portion 51 determines that the update operation has been received (Yes in S44), the control portion 51 shifts the processing to step S45. In addition, when the update operation has not been received (No in S44), the control portion 51 shifts the processing to step S46.

### <Step S45>

In step S45, the control portion 51 updates the job list based on the job information acquired by the second acquisition process before the update operation is received. The process of step S45 is executed by the first display processing portion 84 of the control portion 51.

### <Step S46>

In step S46, the control portion 51 determines whether or not the designation operation of designating any of the print jobs included in the job list has been received.

Here, when the control portion 51 determines that the designation operation has been received (Yes in S46), the control portion 51 shifts the processing to step S47. In addition, when the designation operation has not been received (No in S46), the control portion 51 shifts the processing to step S44.

### <Step S47>

In step S47, the control portion 51 executes the determination process. Here, the process of step S47 is executed by the determination processing portion 85 of the control portion 51.

### <Step S48>

In step S48, the control portion 51 branches the processing in accordance with the result of the determination process. Specifically, when the control portion 51 determines that the print job designated by the designation operation is held in the print server 2 (Yes in S48), the control portion 51 shifts the processing to step S49. In addition, when it is determined that the print job designated by the designation operation is not held in the print server 2 (No in S48), the control portion 51 shifts the processing to step S50.

### <Step S49>

In step S49, the control portion 51 executes the print job designated by the designation operation. The process of step S49 is executed by the execution processing portion 86 of the control portion 51.

### <Step S50>

In step S50, the control portion 51 notifies the user that the print job designated by the designation operation cannot be executed. The process of step S50 is executed by the execution processing portion 86 of the control portion 51.

### <Step S51>

In step S51, the control portion 51 executes the erasing process.

As described above, in the image forming system 100, the job list is displayed in response to the specific operation received after the acquisition process is started. Thus, the waiting time for the user until the job list of the print jobs held in the print server 2 is displayed can be reduced, compared with the configuration in which the acquisition process is started in response to the specific operation and the job list is displayed based on the job information acquired by the acquisition process.

In addition, in the image forming system 100, when the authentication function is enabled, the first acquisition process is started at a timing when the specific function is selected as the function to be used after the second user logs in. Thus, unnecessary execution of the first acquisition process can be suppressed compared with the configuration in which the first acquisition process is started at the timing when the second user logs in. It is noted that the acquisition timing may include any timing after the second user logs in.

### APPENDIXES OF INVENTION

The following are appendixes to the overview of the invention extracted from the above embodiment. It is noted that the structures and processing functions to be described in the following appendixes can be selected and combined arbitrarily.

### APPENDIX 1

An image forming apparatus comprising: an acquisition processing portion configured to start an acquisition process of sequentially acquiring job information of print jobs held in a print server from the print server when a predetermined acquisition timing arrives; and a first display processing portion configured to cause, in response to a predetermined specific operation received after the acquisition timing, a display portion to display a list of the print jobs based on the job information acquired by the acquisition process before the specific operation is received.

### APPENDIX 2

The image forming apparatus according to Appendix 1, further comprising: a login processing portion configured to cause a registered user who is registered in advance to log in, wherein the acquisition timing includes a timing after the login of the registered user, and the acquisition process includes a process of sequentially acquiring the job information of the print jobs corresponding to the logged-in registered user.

### APPENDIX 3

The image forming apparatus according to Appendix 2, further comprising: a second display processing portion configured to cause the display portion to display a function selection screen used to select a function to be used when the registered user logs in, wherein functions selectable on the function selection screen include a specific function for executing a print job held in the print server, and the acquisition timing includes a timing when the specific function is selected as the function to be used on the function selection screen.

### APPENDIX 4

The image forming apparatus according to any one of Appendixes 1 to 3, wherein in response to a predetermined update operation received after the display of the list, the first display processing portion updates the list based on the job information acquired by the acquisition process before the update operation is received.

### APPENDIX 5

The image forming apparatus according to any one of Appendixes 1 to 4, further comprising: a determination processing portion configured to, in response to a designation operation of designating any of the print jobs included in the list displayed by the first display processing portion, determine whether or not the print job designated by the designation operation is held in the print server; and an execution processing portion configured to execute the print job designated by the designation operation when the determination processing portion determines that the print job designated by the designation operation is held in the print server.

### APPENDIX 6

An operation control method comprising: an acquisition step of starting an acquisition process of sequentially acquiring job information of print jobs held in a print server from the print server when a predetermined acquisition timing arrives; and a display step of causing, in response to a predetermined specific operation received after the acquisition timing, a display portion to display a list of the print jobs based on the job information acquired by the acquisition process before the specific operation is received.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an acquisition processing portion configured to start an acquisition process of sequentially acquiring job information of print jobs held in a print server from the print server when a predetermined acquisition timing arrives; and
a first display processing portion configured to cause, in response to a predetermined specific operation received after the acquisition timing, a display portion to display a list of the print jobs based on the job information acquired by the acquisition process before the specific operation is received.

2. The image forming apparatus according to claim 1, further comprising:
a login processing portion configured to cause a registered user who is registered in advance to log in, wherein
the acquisition timing includes a timing after the login of the registered user, and
the acquisition process includes a process of sequentially acquiring the job information of the print jobs corresponding to the logged-in registered user.

3. The image forming apparatus according to claim 2, further comprising:
a second display processing portion configured to cause the display portion to display a function selection screen used to select a function to be used when the registered user logs in, wherein
functions selectable on the function selection screen include a specific function for executing a print job held in the print server, and
the acquisition timing includes a timing when the specific function is selected as the function to be used on the function selection screen.

4. The image forming apparatus according to claim 1, wherein
in response to a predetermined update operation received after the display of the list, the first display processing portion updates the list based on the job information acquired by the acquisition process before the update operation is received.

5. The image forming apparatus according to claim 1, further comprising:
a determination processing portion configured to, in response to a designation operation of designating any of the print jobs included in the list displayed by the first display processing portion, determine whether or not the print job designated by the designation operation is held in the print server; and
an execution processing portion configured to execute the print job designated by the designation operation when the determination processing portion determines that the print job designated by the designation operation is held in the print server.

6. An operation control method comprising:
an acquisition step of starting an acquisition process of sequentially acquiring job information of print jobs held in a print server from the print server when a predetermined acquisition timing arrives; and
a display step of causing, in response to a predetermined specific operation received after the acquisition timing, a display portion to display a list of the print jobs based on the job information acquired by the acquisition process before the specific operation is received.
